(19) United States
(12) Patent Application Publication
(10) Pub. No.: US 2006/0225292 A1
(43) Pub. Date: Oct. 12, 2006

(54) Lineal length measurement system for timber

(75) Inventors: Doug Taylor, Albany, OR (US); Michael A. Gurney, Albany, OR (US); Edwin Diehl III, Scio, OR (US)

Correspondence Address: BAKER & DANIELS LLP, 300 NORTH MERIDIAN STREET, SUITE 2700, INDIANAPOLIS, IN, 46204, US

(73) Assignee: Concept Systems, Inc.

(21) Appl. No.: 11/104,010

(22) Filed: Apr. 11, 2005

(51) Int. Cl. G01D 21/00

(52) U.S. Cl. 33/227

(57) ABSTRACT

A system for measuring timber carried in a direction of travel by a conveyance medium includes a sensor for sensing when a first end of the timber reaches a reference point along the conveyance medium. An optical distance measuring device is aligned with the conveyance medium in the direction of travel. The measuring device measures a distance between the measuring device and a second end of the timber. A processing device is in communication with the sensor and the measuring device. The processing device calculates a length of the timber between the first end and the second end based upon outputs of the sensor and the measuring device.

### BACKGROUND OF THE INVENTION

1. Field of the Invention

The present invention relates to dimensional measurement systems, and, more particularly, to dimensional measurement systems for lumber that is in motion.

2. Description of the Related Art

In the lumber industry, it is often necessary to determine the lengths of individual logs. Such measurements may be performed manually, which requires the use of expensive human labor. Alternatively, the measurements may be performed automatically by mechanical measurement equipment. However, mechanical measurement equipment is typically bulky, inaccurate, expensive, and subject to breakdowns.

It is also known to electronically and automatically measure the lengths of logs by use of point laser measuring devices that are directed at the ends of the logs. One problem associated with the use of point lasers is that the technique does not work if the point laser misses the end of the log that is being measured. Another problem is that the point laser produces only one data point associated with the single point on the end of the log that the laser beam impinges upon. If the single point happens to be an anomaly, i.e., is disposed within a crevice or on a projection on the end of the log, then the one data point collected by the point laser will not be representative of the true length of the log.

Another technique for electronically and automatically measuring the lengths of logs employs three-dimensional (3D) surface scanning technology. In this technique, the laser does not impinge on an end of the log, but rather scans along an entire side surface of the log in both horizontal and vertical directions to thereby generate a 3D model of the log. Once the 3D model is built, the length of the log can be derived. There are several drawbacks associated with 3D surface scanning. First, the ends of the log are not directly sensed, but rather are assumed to be perpendicular to the side surface of the log. If this is not the case, the derivation of the log's length will be inaccurate. Second, the log must be motionless during the scanning process. Third, a relatively long period of time is required to generate the 3D model and derive the length of the log. Lastly, 3D surface scanning is quite expensive to implement.

Yet another technique for electronically and automatically measuring the lengths of logs uses a photoeye coupled with an encoder. Once the photoeye is blocked by a leading end of the log, the current encoder count is read. Monitoring of the encoder counts continues until the photoeye is clear. The total number of encoder counts accumulated while the photoeye was blocked is proportionate to the length of the log. A problem with this technique is that it cannot account for slippage of the log on the belt, and thus the length measurements are not very accurate or reliable.

What is needed in the art is a reliable, accurate and inexpensive log measurement system that does not require human labor or bulky, expensive mechanical measurement equipment.

### SUMMARY OF THE INVENTION

The present invention provides a log measurement system that includes a photoelectric sensing device for detecting when a first end of a log reaches a predetermined point along a conveyance path. An optical distance measuring device is aligned with the log and monitors a distance between the distance measuring device and an opposite, second end of the log. A distance between the distance measuring device and the second end of the log at the instant in time at which the first end of the log reaches the predetermined point along the conveyance path is measured and may be recorded. By subtracting this measured distance from a known distance between the distance measuring device and the predetermined point along a conveyance path, a length of the log can be calculated.

The system may measure materials that have been placed on a conveyor medium transversely, and are to be conveyed lineally, typically to a processing subsystem. The system may include a series of off-the-shelf time-of-flight pulsed laser radar devices to map the surrounding environment, which may return a series of distances in polar coordinates. The system may convert the coordinates (angle and distance) into Cartesian coordinates (x and y), and then filter out the superfluous conveyance and fixed structural obstructions, to thereby obtain a distance from the laser aperture to the end of the material to be measured. At the end of each scan of the laser, the system may monitor the state of a photoelectric sensing device. When the photoelectric sensing device detects that an opposite end of the material to be measured has reached a predetermined point, the system may record the distances between the individual laser radar units and the near end of the material, and the smallest of the distances may be selected. This smallest distance may be subtracted from a known distance between the laser radar units and the predetermined point, thereby arriving at a material length.

The invention comprises, in one form thereof, a system for measuring timber carried in a direction of travel by a conveyance medium, including a sensor for sensing when a first end of the timber reaches a reference point along the conveyance medium. An optical distance measuring device is aligned with the conveyance medium in the direction of travel. The measuring device measures a distance between the measuring device and a second end of the timber. A processing device is in communication with the sensor and the measuring device. The processing device calculates a length of the timber between the first end and the second end based upon outputs of the sensor and the measuring device.

The invention comprises, in another form thereof, a timber measurement system including a conveyance medium for carrying the timber in a direction of travel. An optical sensor senses when a first end of the timber reaches a reference point along the conveyance medium. A plurality of optical distance measuring devices are aligned with the conveyance medium along the direction of travel. Each of the measuring devices measures a distance between the measuring device and a second end of the timber at a respective one of a plurality of levels. The levels are offset from one another in a direction perpendicular to the direction of travel. A processing device is in communication with the sensor and the measuring devices. The processing device calculates a length of the timber between the first end and the second end based upon outputs of the measuring devices when the optical sensor senses that the first end of the timber reaches the reference point along the conveyance medium.

The invention comprises, in yet another form thereof, a timber measurement method including carrying timber along a conveyance path, sensing when a first end of the timber reaches a reference point along the conveyance path, and measuring a distance between a measuring device and a second end of the timber when the first end of the timber reaches the reference point along the conveyance path. A length of the timber between the first end and the second end is calculated based upon the measured distance between the measuring device and the second end of the timber when the first end of the timber reaches the reference point along the conveyance path.

An advantage of the present invention is that it is reliable, accurate and inexpensive.

Another advantage is that the length of a log can be measured without human labor.

Yet another advantage is that the length of a log can be measured without mechanical measurement equipment.

A further another advantage is that the components of the measuring system can also be used to sense when a first log that has been measured has moved far enough along the conveyor that a second log may be placed on the conveyor without risk of colliding with the first log. Thus, a separate photosensor for this purpose is not required.

Still another advantage is that the measurement system can sense the positions of the ends of the logs at different vertical levels. Thus, the system can measure the lengths of logs that have irregularly-shaped ends.

Another advantage is that the timber may be measured despite the timber not moving at a constant speed all times, e.g., being momentarily substantially motionless, due to slippage and/or settling of the timber after being placed on the conveyor.

Yet another advantage is that the system solves some extremely longstanding problems in processing where the material to be measured does not move at all times with the conveyance equipment, which may be due to slippage and settling after placement. With the present invention, the length can be accurately gauged, and the side effect of accurate gap control can be realized by determining if the material has cleared the landing zone for the next item to be measured. The present invention has direct application in the wood products industry as well as in other industries.

A further advantage is that the positions of both ends of the log may continue to be monitored as the log moves along the conveying medium. Thus, it may be easily determined when the log has arrived in position at a next processing station where a next processing operation may be performed on the log.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of one embodiment of a timber measurement system of the present invention.

FIG. 2 is a block diagram of the timber measurement system of FIG. 1.

FIG. 3 is a flow chart of one embodiment of a timber measurement method of the present invention.

FIG. 4 is a perspective view of another embodiment of a timber measurement system of the present invention.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

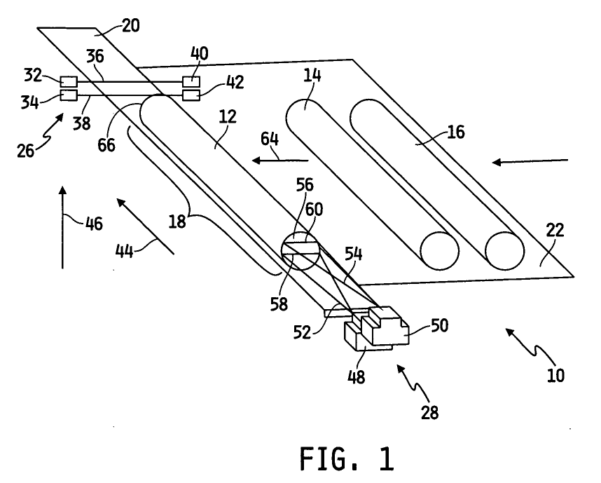

Referring now to the drawings and particularly to FIG. 1, there is shown one embodiment of a timber measurement system 10 of the present invention for measuring the lengths of timbers or wooden logs 12, 14 and 16, such as may be hewn from tree trunks. Timber 12 is supported on a landing area 18 of a moving conveyance medium in the form of a conveyor belt 20. Timbers 14, 16 are disposed on a staging platform 22 from which the timbers may slide or roll onto landing area 18. Platform 22 may be a fixed structure. Landing area 18 may be defined as the section of conveyor belt 20 that is adjacent platform 22 at any given moment.

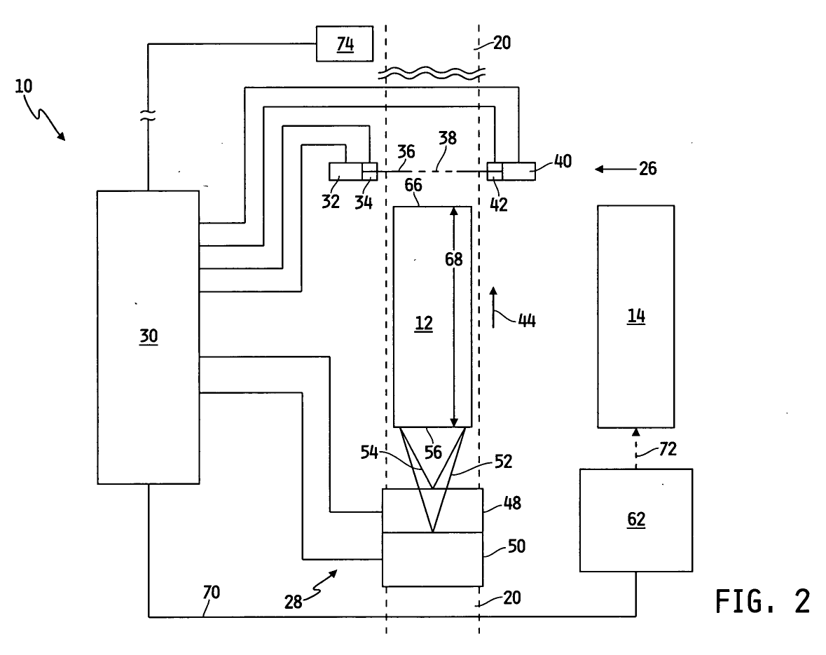

In addition to conveyance medium 20, timber measurement system 10 may include a sensor 26 and an optical distance measuring device 28, both of which may be in communication with a processing device 30, as shown in FIG. 2. Sensor 26 includes optical emitters 32, 34 positioned to transmit respective beams 36, 38 of optical energy to respective optical receivers 40, 42. Emitters 32, 34 may emit beams 36, 38 across the conveyance path of timber 12 as timber 12 is carried in a downstream direction of travel 44 by conveyor belt 20. Timber 12 may block the beams of optical energy from being received by receivers 40, 42 when timber 12 passes between the emitter and the receiver of each of the two pairs. Beams 36, 38 may be offset from one another in a direction 46 perpendicular to direction of travel 44. Conveyor belt 20 may be horizontally oriented, and thus direction 46 may be a vertical direction. In one embodiment, beam 38 is offset approximately four inches in direction 46 from conveyor belt 20. Beam 36, in turn, may be offset another four inches in direction 46 from beam 38, i.e., beam 36 may be offset eight inches in direction 46 from conveyor belt 20. Thus, beams 36, 38 may be evenly spaced across the height of a timber having a diameter of twelve inches. Sensor 26 may be in the form of a light curtain or diameter scanner having an onboard controller that may be represented in FIG. 2 as being a part of processing device 30. The onboard controller may provide information about which of beams 36, 38 are currently blocked by a log. Emitter model number BMEL4832A, receiver model number BMRL4832A, and controller model number MACI-1 from Banner Engineering Corporation of Minneapolis, Minn., U.S.A. may be suitable for use in conjunction with the present invention.

Optical measurement device 28 may be in the form of optical radar devices 48, 50 that scan respective laser beams 52, 54 across an end surface 56 of timber 12. Optical radar devices 48, 50 thus each measure a respective distance between the optical radar device and end surface 56 of timber 12. The scanning of laser beams 52, 54 may define respective planes that are parallel to conveyor belt 20. Thus, if conveyor belt 20 is horizontally oriented, then the scanning directions of beams 52, 54 may also be horizontal. That is, as optical radar devices 48, 50 scan across respective raster lines 58, 60 on end surface 56, raster lines 58, 60 may be horizontally oriented.

Optical radar devices 48, 50 may be offset from one another in direction 46, which is perpendicular to direction of travel 44. In one embodiment, raster line 58, across which optical radar device 48 scans, may be offset approximately four inches in direction 46 from conveyor belt 20. Raster line 60, across which optical radar device 50 scans, may be offset another four inches in direction 46 from raster line 58, i.e., raster line 60 may be offset eight inches in direction 46 from conveyor belt 20. Thus, raster lines 58, 60 may be evenly spaced across the height of a timber having a diameter of twelve inches. In one embodiment, each sweep of each of devices 48, 50 to form rasters 58, 60 has a duration of approximately 50 milliseconds and is processed in near real time by processing device 30.

Optical radar devices 48, 50 may be aligned with conveyor belt 20 in direction of travel 44. That is, at some point along the scanning of raster line 58, laser beam 52 may be parallel to direction of travel 44. Similarly, at some point along the scanning of raster line 60, laser beam 54 may be parallel to direction of travel 44. More particularly, when laser beam 52 is oriented parallel to direction of travel 44, end surface 56 may be reflecting laser beam 52. Similarly, when laser beam 54 is oriented parallel to direction of travel 44, end surface 56 may be reflecting laser beam 54. That is, devices 48, 50 may be detecting timber 12 at the time at which laser beams 52, 54 are parallel to direction of travel 44.

Optical radar devices, such as may be used in optical measurement device 28, may be commonly referred to in the art and commercially as laser radar devices. Such optical radar devices that use diffused laser light to determine distance between the optical radar device and the diffusely reflecting object are well known and are commercially available. Suitable optical radar devices that may be used in conjunction with the present invention may be obtained from SICK Vertriebs—GmbH of Dusseldorf, Germany (model no. LMS211).

Processing device 30 may include memory (not shown) for storing the distances between at least one reference point along conveyor belt 20, such as beams 36, 38 of optical energy, and each of optical radar devices 48, 50. The memory may also include operational software for controlling the outputs of emitters 32, 34, interpreting the outputs of optical receivers 40, 42, and calculating the lengths of timbers 12. Processing device 30 may further be capable of controlling an actuator 62 for moving a next timber 14 in direction 64 when preceding timber 12 has cleared landing area 18. After having calculated the length of timber 12, processing device 30 may also track the locations of ends 56, 66 based upon the measured distance between device 28 and end 56 as timber 12 is moved by conveyor 20. Thus, processing device 30 may determine when timber 12 is in appropriate position for a next processing operation.

Processing device 30 may include any standard microprocessor. In one embodiment, processing device 30 is in the form of a personal computer.

In operation, a timber 12 rolls or otherwise moves in a direction 64 generally perpendicular to direction 44. After timber 12 settles in landing area 18, conveyor belt 20 carries timber 12 in direction 44. Sensor 26 may sense when a leading end 66 of timber 12 passes by a reference point on conveyor belt 20, e.g., passes through one or both beams 36, 38 of optical energy.

Optical distance measuring device 28 measures the distance between device 28 and end surface 56 of timber 12. Device 28 may monitor the distance between device 28 and end surface 56 as soon as timber 12 is received in landing area 18. Alternatively, device 28 may begin measuring the distance between device 28 and end surface 56 when sensor 26 senses leading end 66 of timber 12 passing by a reference point on conveyor belt 20.

Processing device 30 may calculate a length 68 of timber 12 between ends 56, 66 of timber 12 based upon outputs of sensor 26 and measuring device 28. More particularly, processing device 30 may calculate length 68 of timber 12 between first end 66 and second end 56 based upon the measured distance between measuring device 28 and second end 56 of timber 12 at the moment in time when first end 66 of timber 12 reaches the reference point along conveyance medium 20. The positions of beams 36, 38 along belt 20 may serve as the reference points. Processing device 30 may calculate length 68 of timber 12 between first end 66 and second end 56 by subtracting the measured distance between measuring device 28 and second end 56 of timber 12 from a known distance between measuring device 28 and the reference point along conveyance medium 20. That is, when end 66 passes through one or both of beams 36, 38, optical radar devices 48, 50 may measure the distances between devices 48, 50, respectively, and end 56. Processing device 30 may calculate length 68 by subtracting the measured distance between device 48 and end 56 from a known distance between device 48 and one or both of beams 36, 38 that have been interrupted. Similarly, processing device 30 may calculate length 68 by subtracting the measured distance between device 50 and end 56 from a known distance between device 50 and one or both of beams 36, 38 that have been interrupted. Processing device 30 may use either or both of these calculated lengths 68, or an average of the two, to output a length 68 to a user of system 10. That is, processing device 30 may calculate the length of timber 12 between the ends 56, 66 by subtracting the measured distance between a selected one of devices 48, 50 and end 56 from a known distance between the selected one of devices 48, 50 and the reference point along conveyor 20.

After calculating length 68, processing device 30 may monitor positions of first end 66 and second end 56 of timber 12 based upon the calculated length of timber 12 and the measured distance between measuring device 28 and second end 56 of timber 12. That is, optical radar devices 48, 50 may continue monitoring the distances between devices 48, 50, respectively, and end 56. Thus, processing device 30 may track the positions of both ends 56, 66 as timber 12 moves in direction 44. In this way, processing device 30 may determine when timber 12 has cleared landing area 18 and it is safe to transport a next timber 14 to landing area 18. Processing device 30 may then transmit a signal on line 70 instructing actuator 62 to actuate the next timber 14, as indicated in FIG. 2 by dashed arrow 72. Thus, processing device 30 may place another timber on the conveyance path at a time dependent upon the monitoring of the positions of ends 56, 66. Another advantage of monitoring the position of end 56 is that processing device 30 may determine when end 66 reaches another processing station 74 along conveyor belt 20 at which some other processing step may be performed. Processing device 30 may control the operation of processing station 74 based on the determined positions of ends 56, 66.

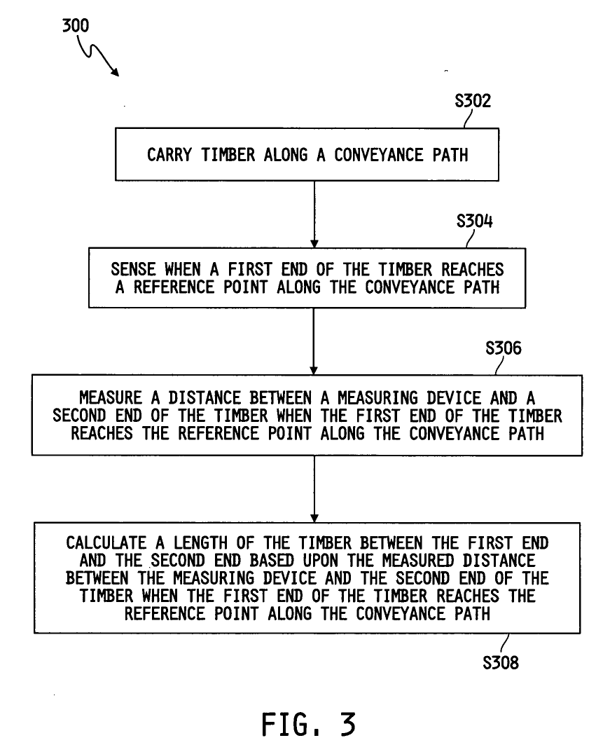

An embodiment of a surveillance method 300 of the present invention is shown in FIG. 3. In a first step (S302) of method 300, a timber is carried along a conveyance path. For example, timber 12 may be carried along a conveyor belt 20. Next, it may be sensed when a first end of the timber reaches a reference point along the conveyance path (step S304). In one embodiment, it may be sensed when end 66 of timber 12 interrupts one or both of beams 36, 38. That is, it may be sensed or detected when timber 12 blocks the optical energy from emitters 32, 34 from being received by respective receivers 40, 42.

In a next step (S306), a distance between a measuring device and a second end of the timber is measured when the first end of the timber reaches the reference point along the conveyance path. For example, optical radar devices 48, 50 may each measure the respective distances between optical radar devices 48, 50 and end surface 56 of timber 12 at the moment in time when end 66 of timber 12 crosses one or both of beams 36, 38. If optical radar devices 48, 50 are continually measuring the ever-changing distances to end 56, and recording the times at which the measurements are made, then processing device 30 may match up the time at which end 66 crosses one or both of beams 36, 38 with a distance measurement made at the same time. If, on the other hand, optical radar devices 48, 50 begin measuring only after end 66 reaches the reference point, there will be some small lag between the time at which end 66 reaches the reference point and the time at which optical radar devices 48, 50 take their first measurements.

In a final step S308, a length of the timber between the first end and the second end is calculated based upon the measured distance between the measuring device and the second end of the timber when the first end of the timber reaches the reference point along the conveyance path. In one embodiment, length 68 of timber 12 is calculated by subtracting the measured distance between one of measuring devices 48, 50 and second end 56 at the point in time when first end 66 intercepts one or both of beams 36, 38. Processing device 30 may compensate for any small time lag between sensing of first end 66 and measurement of second end 56 by calculating, based on a known speed of belt 20, the distance traveled by timber 12 during the time lag. This calculated travel distance may be added to the measured length of timber 12. However, it is also possible that this calculated travel distance is negligible and may be ignored in calculating length 68.

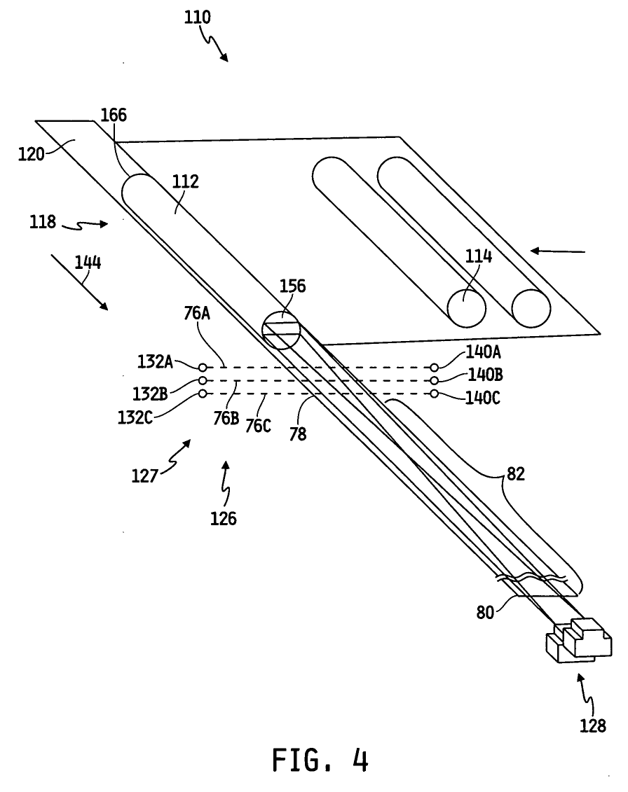

In another embodiment of a timber measurement system 110 of the present invention shown in FIG. 4, timber 112 is carried toward optical distance measuring device 128 in direction 144 by a conveyance medium 120. An optical sensor 126 includes a light curtain 127 including matched pairs of emitters 132a-c and receivers 140a-c.

In operation, when timber 112 is initially placed on conveyance 120, timber 112 does not block the transmission of optical energy from emitters 132 to receivers 140. When end 156 of timber 112 passes by a reference point 78 on conveyance 120, i.e., passes through light curtain 127, timber 112 begins to block the optical energy transmitted from emitters 132 to receivers 140. At the moment in time at which receivers 140 begin to again receive the optical energy, i.e., when end 166 passes by point 78, device 128 measures the distance between device 128 and end surface 156 of timber 112. A processing device (not shown) may then calculate a length of timber 112 between ends 156, 166 by subtracting the measured distance between device 128 and end 156 from a known distance between device 128 and reference point 78, i.e., light curtain 127.

Device 128 may continue to monitor the position of end 156 in order to determine, based on the known length of timber 112, when timber 112 has cleared a landing area 118 for a subsequent timber 114. As timber 112 continues in direction 144, device 128 may also continue to monitor the position of end 156 and, based on the known length of timber 112, the position of end 166 so that the processing device may determine when ends 156, 166 are in appropriate position for a subsequent processing operation at a subsequent processing station (not shown). When end 156 of timber 112 reaches point 80, timber 112 may be “kicked off” or otherwise removed from conveyance 120. A portion 82 of conveyance 120 between light curtain 127 and point 80 may have a length that is greater than the length of any timber to be measured. Other features of system 110 are similar to those of system 10, and are not disclosed in further detail herein in order to avoid needless repetition.

The timber measurement system of the present invention has been disclosed herein as including two optical radar devices and a sensor having two or three optical emitter/receiver pairs. However, it is to be understood that a timber measurement system of the present invention may include any number of optical radar devices and any number of optical emitter/receiver pairs, depending upon the degree of resolution and/or redundancy desired in the system.

The conveyance medium has been disclosed herein as being in the form of a conveyor belt. However, it is to be understood that the present invention may be used with a conveyance medium of another form. For example, the conveyance medium may be water flowing in a river, or in another type of conduit, wherein the timber floats on the surface of the water.

While this invention has been described as having an exemplary design, the present invention may be further modified within the spirit and scope of this disclosure. This application is therefore intended to cover any variations, uses, or adaptations of the invention using its general principles.

What is claimed is:

1. A system for measuring timber carried in a direction of travel by a conveyance medium, said system comprising:
a sensor configured to sense when a first end of the timber reaches a reference point along the conveyance medium;
an optical distance measuring device configured to be aligned with said conveyance medium in the direction of travel, said measuring device being configured to measure a distance between said measuring device and a second end of the timber; and
a processing device in communication with said sensor and said measuring device, said processing device being configured to calculate a length of the timber between the first end and the second end based upon outputs of said sensor and said measuring device.

2. The system of claim 1 wherein said processing device is configured to calculate the length of the timber between the first end and the second end based upon the measured distance between said measuring device and the second end of the timber when the first end of the timber reaches the reference point along the conveyance medium.

3. The system of claim 2 wherein said processing device is configured to calculate the length of the timber between the first end and the second end by subtracting the measured distance between said measuring device and the second end of the timber from a known distance between said measuring device and the reference point.

4. The system of claim 1 wherein said sensor comprises an optical emitter positioned to transmit optical energy to an optical receiver, wherein the timber blocks the optical energy from being received by said receiver when the timber passes between said emitter and said receiver.

5. The system of claim 1 wherein said optical distance measuring device comprises a laser radar device.

6. The system of claim 1 wherein said processing device is further configured to monitor positions of the first end and the second end of the timber based upon the calculated length of the timber and the measured distance between said measuring device and the second end of the timber.

7. A timber measurement system, comprising:
a conveyance medium configured to carry the timber in a direction of travel;
an optical sensor configured to sense when a first end of the timber reaches a reference point along said conveyance medium;
a plurality of optical distance measuring devices aligned with said conveyance medium along the direction of travel, each of said measuring devices being configured to measure a distance between said measuring device and a second end of the timber at a respective one of a plurality of levels, the levels being offset from one another in a direction perpendicular to the direction of travel; and
a processing device in communication with said sensor and said measuring devices, said processing device being configured to calculate a length of the timber between the first end and the second end based upon outputs of said measuring devices when said optical sensor senses that the first end of the timber reaches said reference point along said conveyance medium.

8. The system of claim 7 wherein said sensor comprises a plurality of optical emitters and a plurality of optical receivers, each of said emitters being positioned to transmit a beam of optical energy to a respective one of said receivers, the beams being offset from one another in the direction perpendicular to the direction of travel.

9. The system of claim 8 wherein the timber blocks the optical energy from being received by at least one of said receivers when the timber passes by the reference point.

10. The system of claim 7 wherein said processing device is configured to calculate the length of the timber between the first end and the second end by subtracting the measured distance between a selected one of said measuring devices and the second end of the timber from a known distance between said selected measuring device and the reference point.

11. The system of claim 7 wherein said optical distance measuring devices comprise a plurality of laser radar devices.

12. The system of claim 7 wherein said processing device is further configured to monitor positions of the first end and the second end of the timber based upon the calculated length of the timber and the measured distances between said measuring devices and the second end of the timber.

13. The system of claim 7 wherein each of said optical distance measuring devices scans along a respective raster line on the second end of the timber, the raster lines being substantially parallel to one another and offset from one another in the direction perpendicular to the direction of travel.

14. A timber measurement method, comprising:
carrying timber along a conveyance path;
sensing when a first end of the timber reaches a reference point along the conveyance path;
measuring a distance between a measuring device and a second end of the timber when the first end of the timber reaches the reference point along the conveyance path; and
calculating a length of the timber between the first end and the second end based upon the measured distance between the measuring device and the second end of the timber when the first end of the timber reaches the reference point along the conveyance path.

15. The method of claim 14 wherein said calculating step includes subtracting the measured distance between said measuring device and the second end of the timber from a known distance between said measuring device and the reference point.

16. The method of claim 14 wherein said sensing step includes:
transmitting optical energy from an optical emitter to an optical receiver; and
detecting the timber blocking the optical energy from being received by said receiver when the timber passes between said emitter and said receiver.

17. The method of claim 14 wherein the measuring step includes scanning optical energy along a raster line on the second end of the timber.

18. The method of claim 14 wherein the measuring step includes scanning optical energy along a plurality of raster lines on the second end of the timber, the raster lines being substantially parallel and offset from one another in a direction substantially perpendicular to the length of the timber.

19. The method of claim 14 comprising the further steps of:
measuring the distance between said measuring device and the second end of the timber at times after the first end of the timber reaches the reference point; and
monitoring positions of the first end and the second end of the timber based upon the calculated length of the timber and the measured distances.

20. The method of claim 18 comprising the further step of placing another timber on the conveyance path at a time dependent upon the monitoring step.
